(19) United States
(12) Patent Application Publication
(10) Pub. No.: US 2013/0318167 A1
(43) Pub. Date: Nov. 28, 2013

(54) METHOD AND APPARATUS FOR PROVIDING EXCHANGE OF PROFILE INFORMATION

(71) Applicant: Aaron SEREBOFF, Owings Mills, MD (US)

(72) Inventors: Aaron P. SEREBOFF, Owings Mills, MD (US); Michael L. KAESSNER, Longmont, CO (US); Christopher D. NEWMAN, Boulder, CO (US)

(73) Assignee: Aaron SEREBOFF, Owings Mills, MD (US)

(21) Appl. No.: 13/959,263

(22) Filed: Aug. 5, 2013

Related U.S. Application Data
(63) Continuation-in-part of application No. 12/469,639, filed on May 20, 2009.

(51) Int. Cl. H04L 29/08

(52) U.S. Cl. CPC H04L 67/306
USPC 709/204

(57) ABSTRACT

An approach for providing an exchange of profile information by using anonymous identifiers is described. An information exchange platform may select one of a plurality of device identifiers specific to corresponding one or more devices. The information exchange platform may also cause, at least in part, a transmission of the selected device identifier to another device separate from the one or more devices. Further, the plurality of device identifiers may be associated with one or more user profiles.

### RELATED APPLICATIONS

This application is a continuation-in-part of application Ser. No. 12/469,639, filed May 20, 2009, entitled “Web Traffic Driven Information Exchange,” the entirety of which is incorporated herein by reference.

### BACKGROUND

Common methods for exchanging business or personal information (e.g., name, phone number, email address, location address, etc.) are accomplished by exchanging pre-printed business cards or by word of mouth. However, such business cards cannot be changed or updated once printed, and are limited in the quantity and type of information that can be included. Further, word of mouth is not an effective mode of exchanging information as people tend to forget information obtained through word of mouth.

In the meantime, as another method for exchanging business or personal information, web addresses (e.g., URL) or email addresses associated with a personal or business webpage (e.g., blog, social network page, etc.) are commonly exchanged as internet and social network services' (e.g., Facebook®, Twitter®, LinkedIn®, etc.) users increase. However, because business or personal webpages may contain information of varying levels of privacy, such webpages may not be a desirable method to exchange personal information, as it may lead to more information disclosure than necessary. In addition, mobile phones have been used to exchange contact information. However, today's mobile phones may not always be accessible as mobile phones may be restricted in many areas and settings for various reasons (e.g., interrupting noise, information security, etc.).

### Some Example Embodiments

Therefore, there is a need for an approach for providing an exchange of profile information by using anonymous identifiers.

According to one embodiment, a method comprises selecting one of a plurality of device identifiers specific to corresponding one or more devices, wherein the plurality of device identifiers are associated with one or more user profiles. The method also comprise initiating transmission of the selected device identifier to another device separate from the one or more devices.

According to another embodiment, an apparatus comprises at least one processor, and at least one memory including computer program code for one or more computer programs, the at least one memory and the computer program code configured to, with the at least one processor, cause, at least in part, the apparatus to select one of a plurality of device identifiers specific to corresponding one or more devices, wherein the plurality of device identifiers are associated with one or more user profile. The apparatus is also caused to cause, at least in part, a transmission of the selected device identifier to another device separate from the one or more devices.

According to another embodiment, a computer-readable storage medium carries one or more sequences of one or more instructions which, when executed by one or more processors, cause, at least in part, an apparatus to select one of a plurality of device identifiers specific to corresponding one or more devices. The apparatus is also caused to cause, at least in part, a transmission of the selected device identifier to another device separate from the one or more devices.

According to another embodiment, an apparatus comprises means for selecting one of a plurality of device identifiers specific to corresponding one or more devices. The apparatus also comprises means for causing, at least in part, a transmission of the selected device identifier to another device separate from the one or more devices.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for a handheld device capable of providing an exchange of profile information by using anonymous identifiers, according to one embodiment;

FIG. 2 is a diagram illustrating initial states of the handheld devices capable of providing an exchange of profile information by using anonymous identifiers, according to one embodiment;

FIGS. 3A-3B are diagrams illustrating an exchange of devices identifiers among the handheld devices, according to various embodiments;

FIGS. 4A-4C are diagrams illustrating accessibility of the handheld devices, according to various embodiments;

FIG. 5 is a diagram illustrating account information associated with one of users of the handheld devices, according to one embodiment;

FIG. 6 is a diagram illustrating account information associated with an event organizer that provides the handheld devices, according to one embodiment;

FIG. 7 is a diagram illustrating a scenario where a local vendor allows users to prepay for and claims goods and services by using the handheld devices, according to one embodiment;

FIG. 8 is a flowchart illustrating operations for exchanging device identifiers between two or more of the handheld devices, according to one embodiment;

FIG. 9 is a flowchart illustrating operations for connecting a user to a web server and accessing information about other users through the web server, according to one embodiment;

FIG. 10 is a flowchart illustrating operations for configuring the handheld devices for an event, according to one embodiment;

FIG. 11 is a flowchart illustrating operations for prepaying for goods or services accessed by using the handheld device, according to one embodiment;

FIG. 12 is a flowchart illustrating operations for restoring account settings from a lost handheld device, according to one embodiment;

FIG. 13 is a flowchart of a process for providing an exchange of profile information by using anonymous identifiers, according to one embodiment;

FIGS. 14A-14D are diagrams illustrating a handheld device for providing an exchange of profile information by using anonymous identifiers, according to various embodiments;

FIG. 15 is a diagram of hardware that can be used to implement an embodiment of the invention; and

FIG. 16 is a diagram of a chip set that can be used to implement an embodiment of the invention.

### DESCRIPTION OF SOME EMBODIMENTS

Examples of a method, apparatus, system, and computer program for providing an exchange of profile information by using anonymous identifiers are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

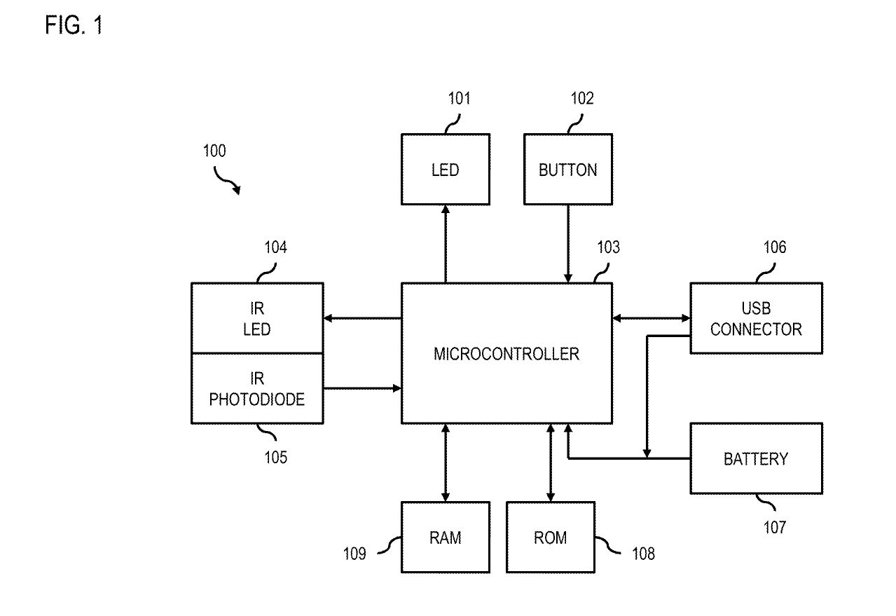

FIG. 1 is a diagram of a system capable of providing an exchange of profile information by using anonymous identifiers, according to one embodiment. Common methods for exchanging business or personal information (e.g., name, phone number, email address, location address, etc.) are achieved by exchanging pre-printed business cards or by word of mouth. However, business cards cannot be changed or updated once printed, and are physically limited in the quantity and type of information that can be included. Further, word of mouth is not an effective mode of exchanging information as people tend to forget information obtained through word of mouth.

In the meantime, increasing numbers of internet and social network services (e.g., Facebook®, Twitter®, LinkedIn®, etc.) users are exchanging business or personal information, web addresses (e.g., URL), or email addresses associated with a personal or business webpage (e.g., blog, social network page, etc.). However, because the business or personal webpage may contain various levels of information, it may not be desirable to exchange web addresses as it may lead to a greater level of information disclosure than desired. For example, it may be desirable to share only an email address, rather than a home address and telephone number to a new acquaintance. Additionally, in social settings, it may be awkward to grant varying levels of access to multiple individuals at the same or nearly the same time. Also, mobile phones have been used to exchange contact information. However, mobile phones may have limited accessibility as they are prohibited in some areas and settings for various reasons (e.g., interruptive noise notifications, information security, etc.).

To address this problem, a system 100 of FIG. 1 introduces the capability to provide an exchange of profile information by using anonymous identifiers. In one embodiment, as will be discussed in further detail below, the presently disclosed technology contemplates a device that is small, inexpensive, and that exchanges identification (ID) numbers associated with the device. These numbers are unique to the device and are associated with user accounts on a web site used for contact information exchange, shared interest information, images, business advertising, and so forth. Each user can have multiple aliases or device IDs associated with his/her site so that multiple devices or a device that stores multiple IDs can be used.

FIG. 1 is a diagram of a system for a handheld device capable of providing an exchange of profile information by using anonymous identifiers, according to one embodiment. In one embodiment, the system 100 includes a microcontroller (or a processor) 103 that is coupled to a read-only memory (ROM) 108, such as a flash ROM 108, and to a random access memory 109.

In one embodiment, the memories 108, 109 are embedded within the same integrated circuit as the microcontroller 103. The microcontroller 103 is also coupled to a push-button switch (or a selector) 102, a light-emitting diode (LED) 101, an infrared (IR) LED 104, an IR photodiode 105, a Universal Serial Bus (USB) connector 106, and a battery 107. However, not all implementations of the system 100 need to be equipped with all of the read-only memory (ROM) 108, random access memory 109, push-button switch (or selector) 102, light-emitting diode (LED) 101, infrared (IR) LED 104, IR photodiode 105, Universal Serial Bus (USB) connector 106, and battery 107 components.

In one embodiment, one or more application programs that embody methods for exchanging information disclosed in detail below are programmed into the ROM 108 and are executed by the microcontroller 103. The RAM 109 is employed for data storage and retrieval during execution of the one or more application programs.

In one embodiment, the switch 102 is operable by a user and the LED 101 provides visual feedback to the user. The battery 107 powers the microcontroller 103, and may be replaceable when the system 100 is operating remotely (e.g., during a trade show or similar social event). The USB connector 106 couples the device to a user's desktop computer, laptop computer, or similarly featured device, to send/receive data or recharge the system 100. When the system 100 is coupled to a computer via the USB connector 106, power for the microcontroller 103 can be provided from a USB port on the computer. In one embodiment, the battery 107 also includes charging circuitry that provides for recharge of the battery when the system 100 is coupled to the computer. In one implementation, the system 100 has multiple LEDs 101 or other indicators that correspond to multiple device IDs and/or multiple switches (or selectors) 102 to select the multiple device IDs.

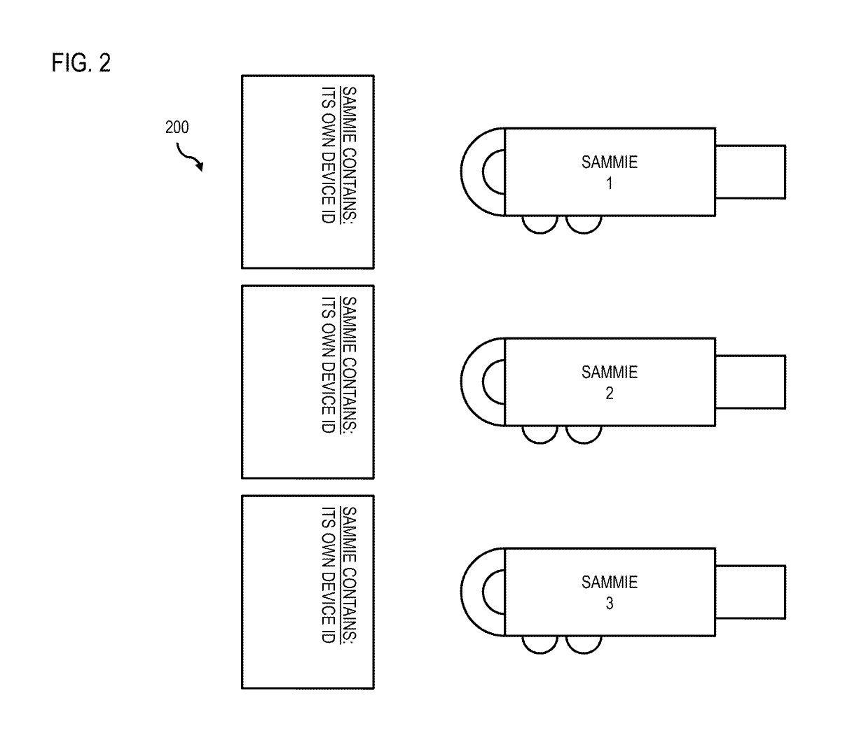

In one embodiment, the system 100 may include Bluetooth and/or Near Field Communication (NFC) modules that may enable connection and communication between the system 100 and other system 100, or another device, including: a mobile phone, a personal computer, a tablet PC, etc. Usage scenarios for the presently disclosed technology are discussed below with reference to FIGS. 2-11. As used herein, the term “Sammie device” refers to the handheld device included in the system 100, which implements the processes described herein.

FIG. 2 is a diagram illustrating initial states of the handheld devices (Sammie devices 200) capable of providing an exchange of profile information by using anonymous identifiers, according to one embodiment. For example, the three exemplary Sammie devices 200 (Sammie device 1, Sammie device 2, and Sammie device 3) are provided to attendees at a trade show or other event. The Sammie devices 200 may be given to all or selected attendees at the trade show or the other event. In one implementation, the three devices of FIG. 2 are assigned unique device IDs (e.g., MAC addresses) and are given to three disparate attendees. The Sammie devices 200 may not contain any actual contact information for their respective users, but merely serve as anonymous device IDs.

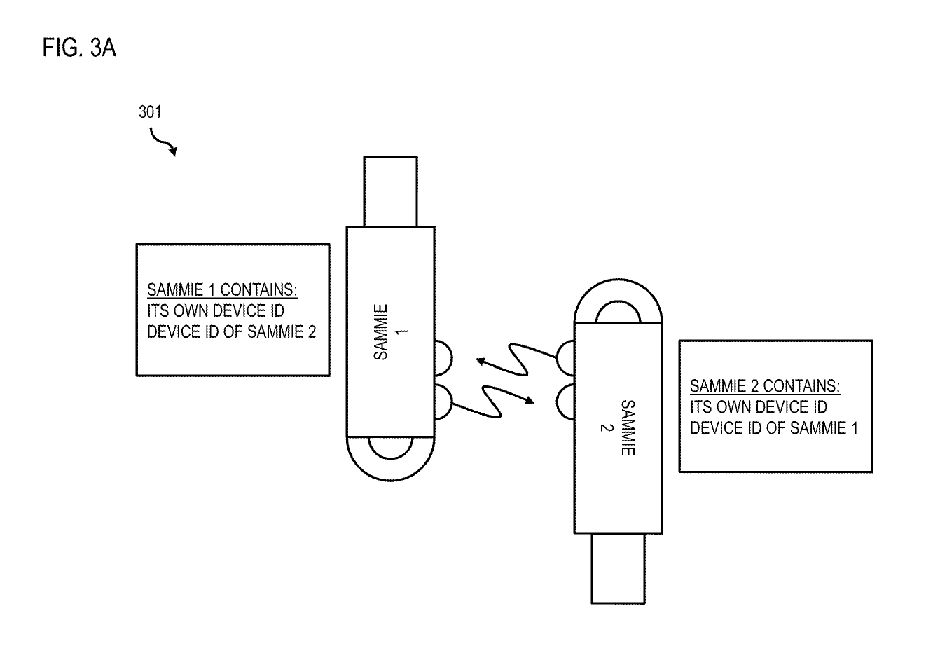

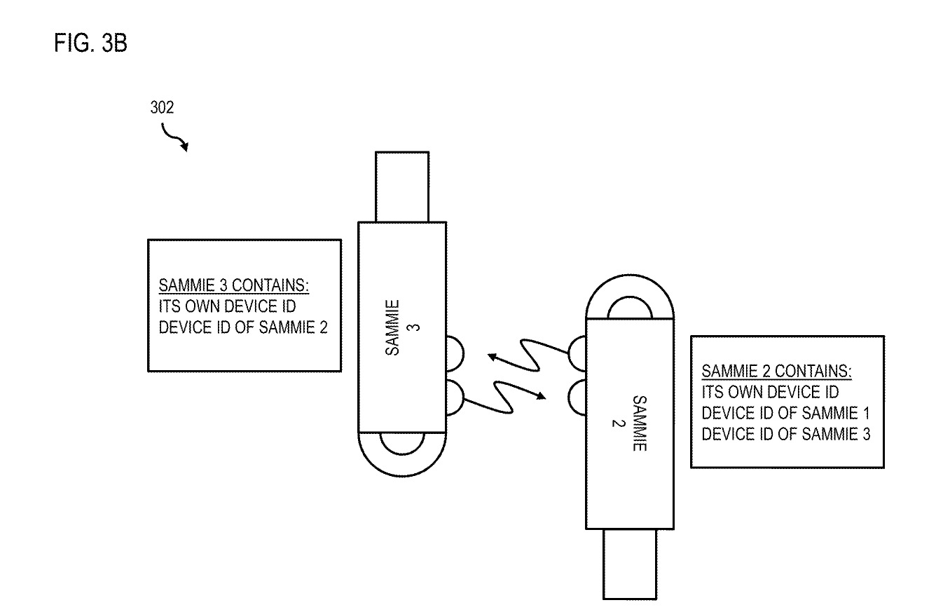

FIGS. 3A-3B are diagrams illustrating an exchange of devices identifiers among the handheld devices (Sammie devices 200), according to various embodiment. FIG. 3A illustrates an exchange scenario 301 of device IDs between Sammie 1 and Sammie 2 of FIG. 2. In the exchange scenario 301, a User 1 and a User 2 decide that they want to be able to contact each other after the event, so they “connect” with each other by activating a switch and observing visible feedback from an LED on their respective devices. An IR LED on each device transmits the device ID and a photodiode is employed to receive transmitted information from the other device. Thus, following transmission and reception of device IDs, each of the devices now contains the other device's ID number.

In one implementation, there are multiple switches on each device corresponding to unique device IDs. For example, one device ID may be associated with a user's personal profile. A second device ID may be associated with a user's business profile. By providing the ability to select a device ID associated with a specific profile, the user may more effectively allow access to personal information appropriate to his/her new contact. In one embodiment, the Bluetooth and/or NFC modules may be used to transmit and received the device ID.

FIG. 3B illustrates an exchange 302 of device IDs between Sammie device 2 and Sammie device 3 of FIG. 2, according to one embodiment. Similar to exchange scenario 301, in scenario 302, the User 2 and a User 3 execute an exchange of device IDs. Thus, following the exchange scenario 301, Sammie device 3 now contains the device ID of Sammie device 2, and Sammie device 2 now contains the device ID of Sammie device 3 in addition to the device ID of Sammie device 1 in memory.

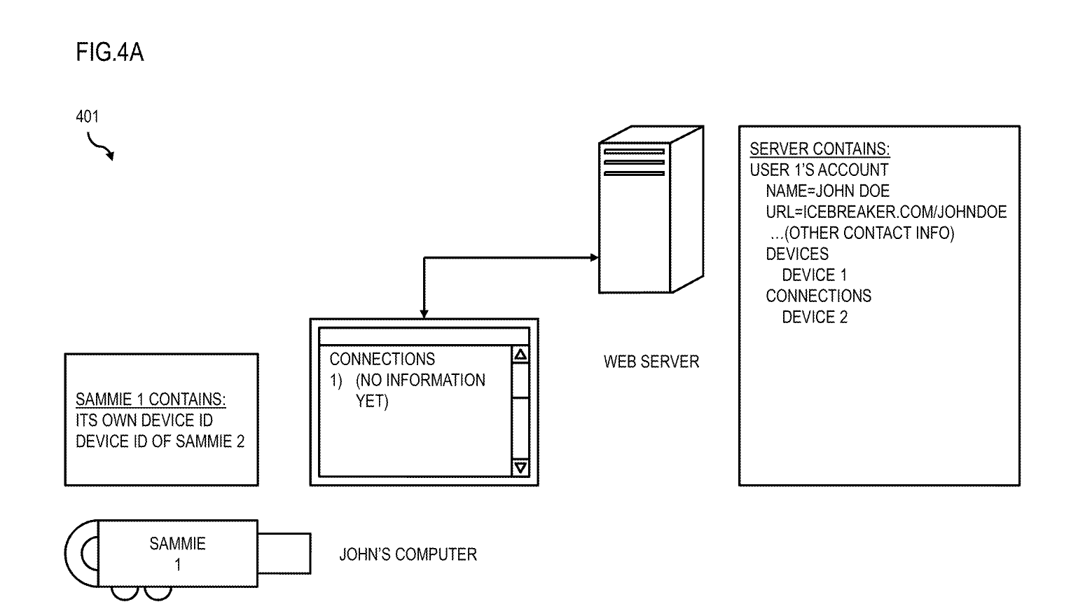

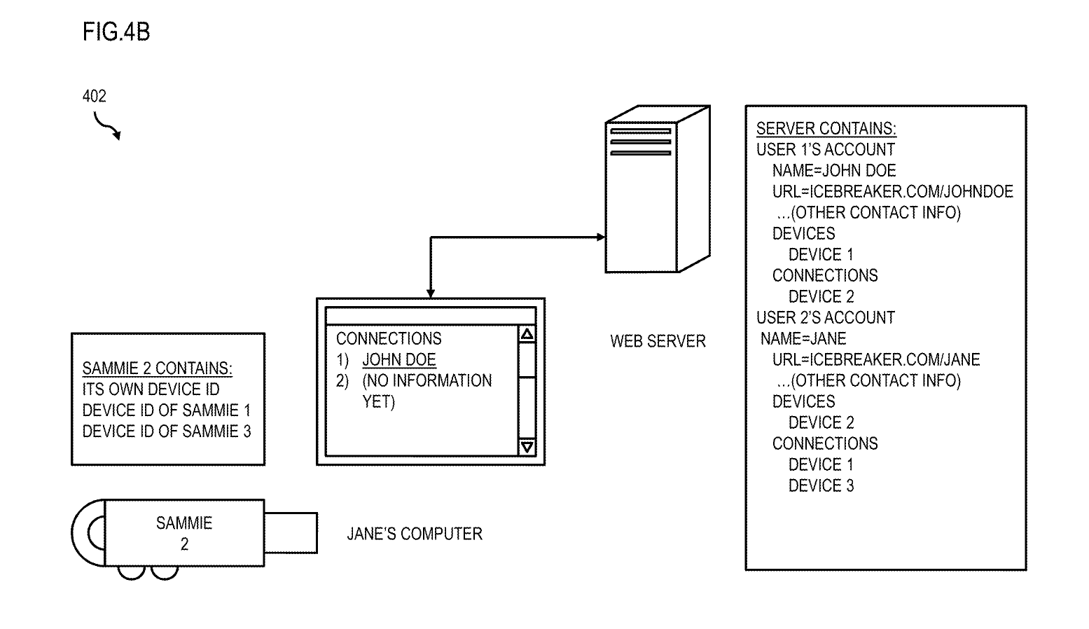

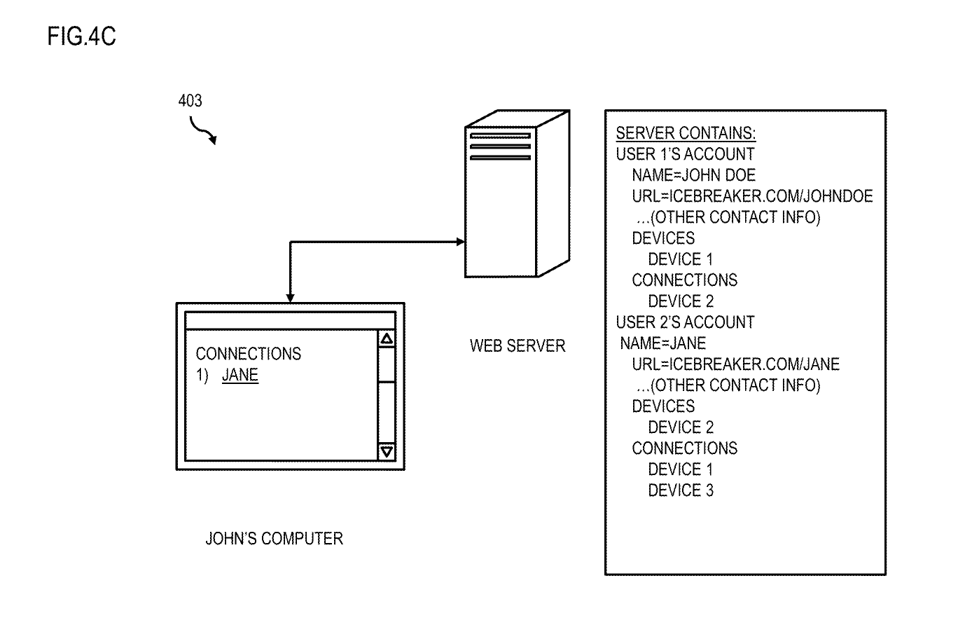

FIGS. 4A-4C are diagrams illustrating accessibility of the handheld devices (Sammie devices 200), according to various embodiments. FIG. 4A illustrates an example scenario 401 for accessing information by coupling the Sammie device 1 to a computing system. In scenario 401, User 1 (John) arrives home first, plugs the Sammie device 1 into his computer, which takes him to a website or a web server that is configured to store user information and to control access to the stored information. The device ID(s) of Sammie device 1 and exchanged device IDs stored in Sammie device 1 are uploaded to the website. John creates an account, or logs into an existing account. The device ID(s) of Sammie device 1 are now associated with John's account. John's account indicates that he connected with one person (User 2), but that person does not yet have any information associated with their device (Sammie device 2), so he is advised to check back later.

In one embodiment the access to the stored information may be controlled with regard to the device ID(s) associated with the stored information. For example, on the website or through an application, the user may preset the access levels associated with the stored information and/or the device IDs. The access levels may be associated with various portions of the stored information or different types of the stored information. For example, the access levels may be associated with either public or private portions of one's profile information, or may be associated with business or personal profile information. FIG. 4B illustrates an example scenario 402 for accessing information by coupling the Sammie device 2 to a computing system, according to one embodiment. In scenario 402, and in like manner, User 2 (Jane) arrives home and couples her device (Sammie device 2) to her computer. Her device ID(s) and exchanged IDs are uploaded to the website or the web server. Jane additionally adds information to her account. After uploading her exchanged IDs, Jane can now see John's (User 1) information, but not User 3 information because User 3 has not added information to his/her account.

FIG. 4C illustrates an example scenario 404 for accessing information by coupling the device 3 to a computing system, according to one embodiment. In scenario 403, John subsequently returns to the website and is able to access Jane's information that she provided in scenario 402.

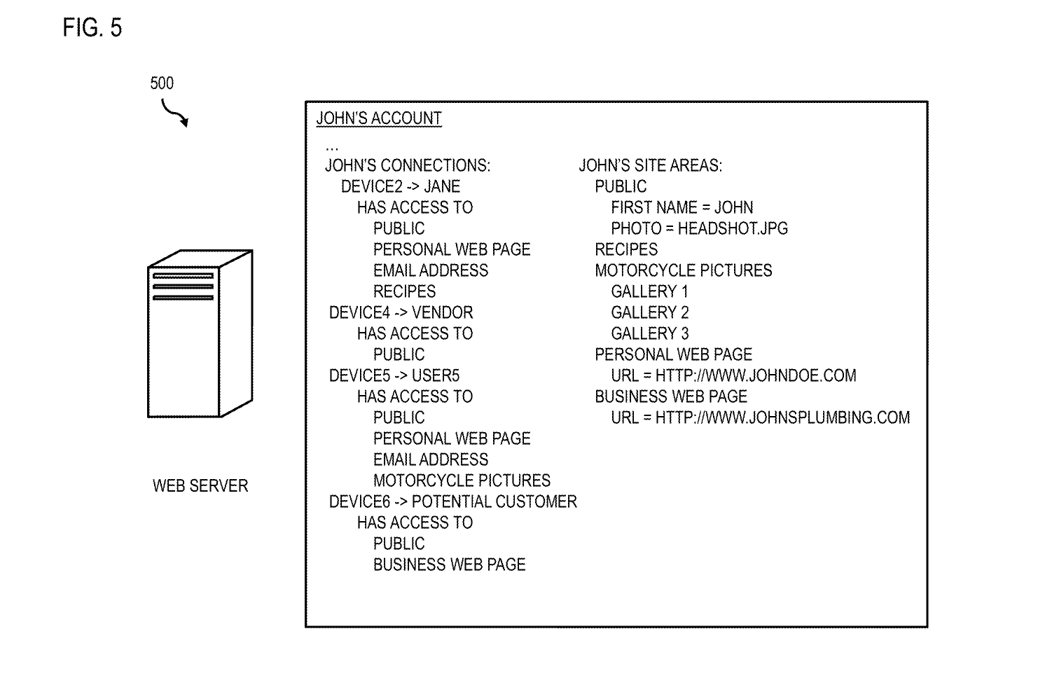

FIG. 5 is a diagram illustrating account information 500 associated with one of the users of the handheld devices (Sammie devices 200), according to one embodiment. For example, the information 500 is stored on the website or the web server and accessible to John. The details of John's account show that he now has connections with four people (corresponding to Sammie devices 2, 4, 5 and 6). Further, John has added some pictures, recipes, and links, and has given users access to different areas of his site. Users that John connects with by default only have access to his public area, which just has his first name and a picture of him. Jane showed interest in John's recipes, so John used the web interface to give her access to his recipes. John also gave Jane access to his email address and personal web page.

In addition, John connected with a vendor using Device 4 while at the trade show. Since John does not want to be contacted by the vendor, he left that connection in its default state (public), which only gives the vendor access to John's first name and picture. The vendor's account (not shown), gives everyone access to the vendor's product information. Therefore, John can get what he needs from the vendor.

Furthermore, the information 500 shows that John later met User 5 with Sammie device 5. User 5 was interested in John's motorcycle, so John gave User 5 access to his motorcycle pictures.

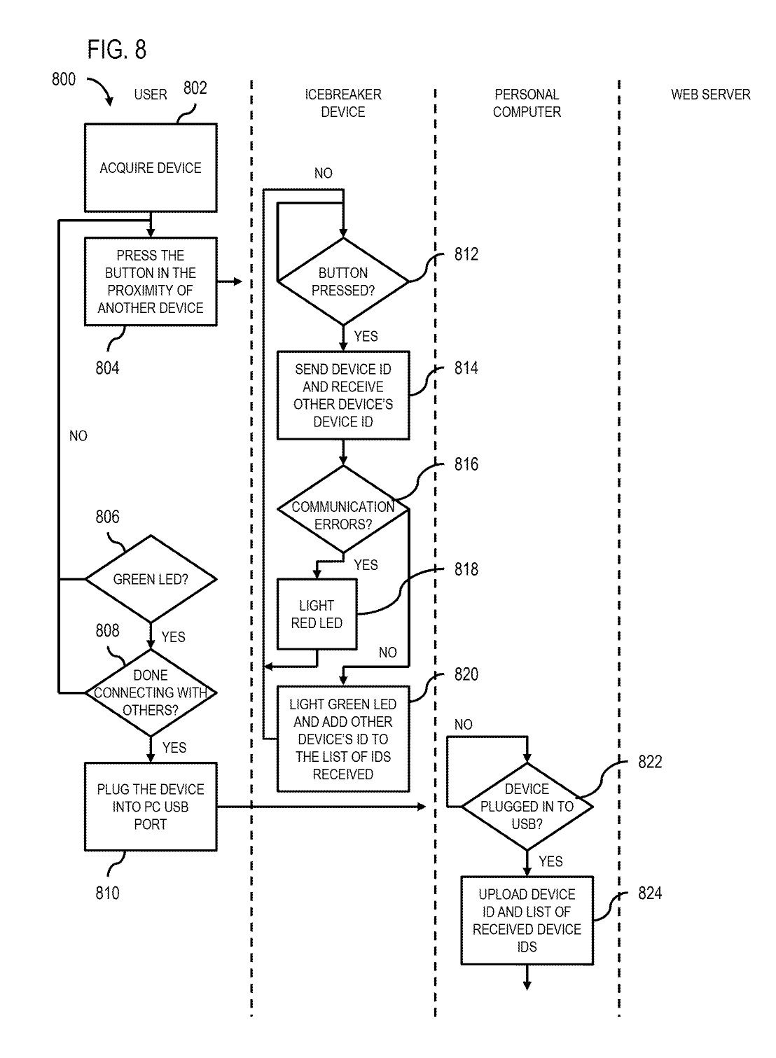

Moreover, John also met User 6 (Potential Customer) who is interested in hiring John. Thus, John gave User 6 access to John's business web page. Multiple device IDs may be provided on a Sammie device to customize user information to be presented to various groups of contacts. For example, one device ID may correspond to a personal user profile and another device ID may correspond to a business user profile. The content of FIGS. 2-5 is further described with respect to a method for connecting users in the flowchart 800 of FIG. 8.

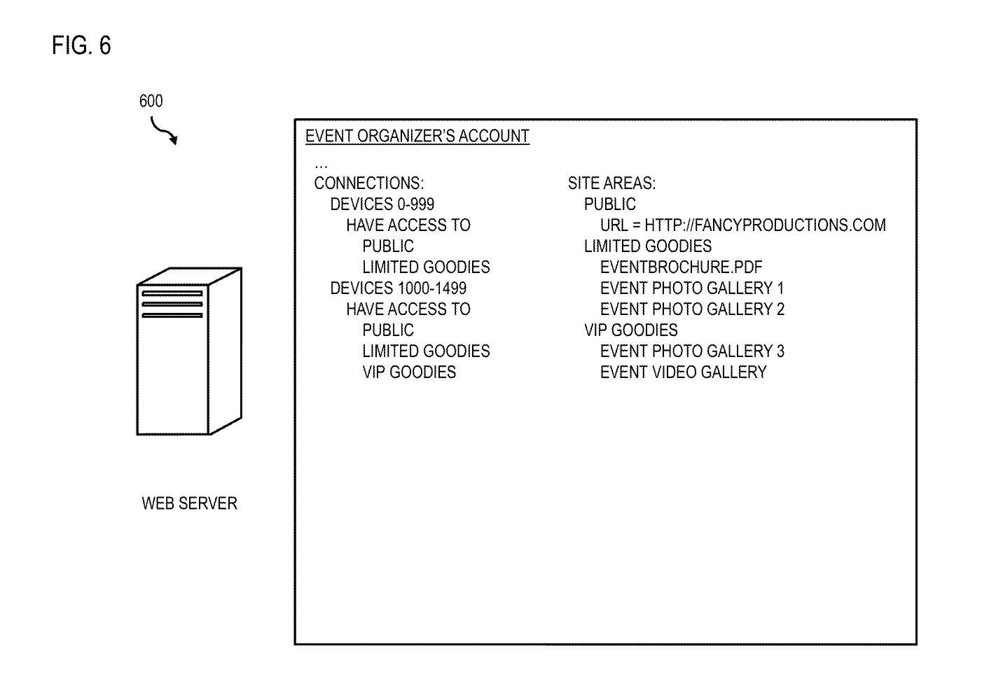

FIG. 6 is a diagram illustrating account information 600 associated with an event organizer that provides the handheld devices (Sammie devices 200), according to one embodiment. For example, the information 600 is stored on the website or the web server accessible by an event organizer. The event organizer provides access to information regarding an event. Buyers of more expensive event tickets are provided devices out of the box numbered 1000-1499, which give access to a special VIP area of the site. Those which have purchased less expensive tickets are given devices 0-999, which restrict access to only public information and limited take-home items.

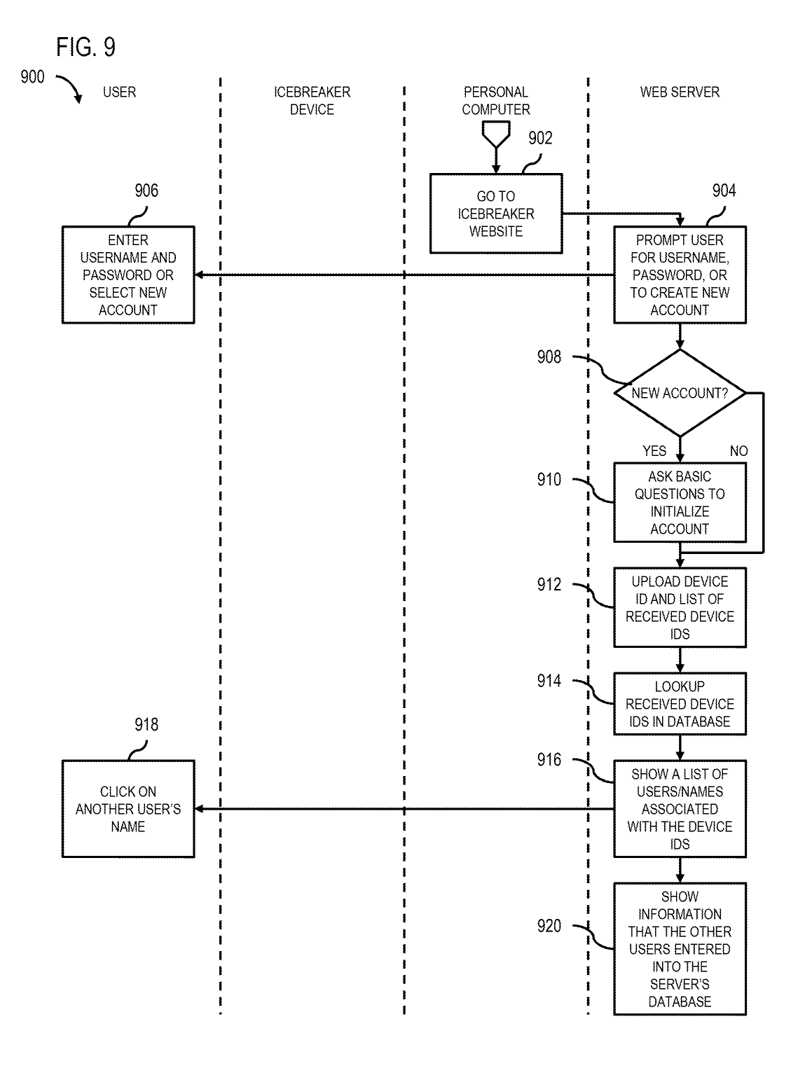

In one embodiment, the event organizer might give the Sammie devices to all ticket buyers. Since the event organizer is not required to physically connect with each of the devices, the event organizer can program the event organizer account to provide different levels of access to different ticket buyers. While only two access levels are shown in FIG. 6, the presently disclosed technology contemplates more than two levels of access and privileges. The content of FIG. 6 is further described with respect to a method for configuration of the devices for an event in the flowchart 900 of FIG. 9.

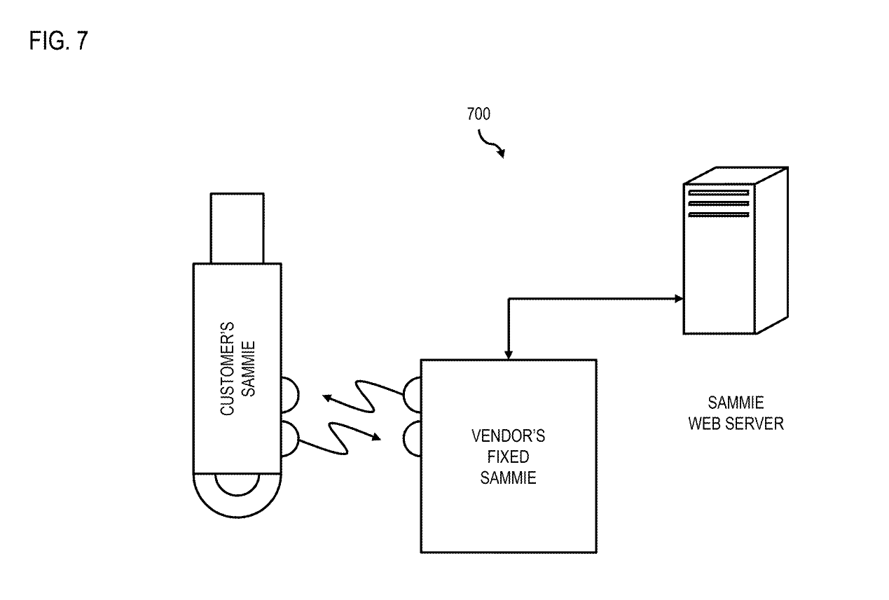

FIG. 7 is a diagram illustrating a scenario 700 where a local vendor allows users to prepay for and claim goods and services by using the handheld devices (Sammie devices 200), according to one embodiment. For example, a local vendor with a fixed account may allow event attendees to prepay online for goods and services provided at the event. The attendee (e.g., a customer) might prepay for goods or services online prior to an event, and then redeem the goods and services locally. For instance, the user might buy tickets to the event online through the user's Sammie account that is associated with the user's device. When the user arrives at the event, the user does not need to wait at will-call. Instead, the user simply connects his/her device with the event's fixed Sammie device where tickets are taken.

One advantage of this technique is that a paperless method for admission is provided, which is commonly assumed to be environmentally friendly. This advantage may be particularly desirable in certain social situations where the so-called “Green” movement is popular. Customers who buy goods or services (e.g., coffee) could also use the scenario 700 of FIG. 7. For example, customers that frequently use a particular vendor and want to prepay a certain number of dollars can have the purchase amount deducted automatically the customer's account. This provides the vendor with an opportunity to provide incentives for large deposits. Further, the customer is not required to carry money or credit cards, which are both subject to theft.

In another example of the scenario 700 of FIG. 7, according to one embodiment, coupons received through e-mail or on a website could be associated with the customer's device. Grocery stores could use the customer's device as a method of tracking buying trends (similar to how grocery stores currently use club cards), without issuing club cards. If the customer's Sammie device is lost or stolen, the customer's account can easily be associated with a new Sammie device. The lost or stolen device can then be deactivated without requiring any action by the vendor.

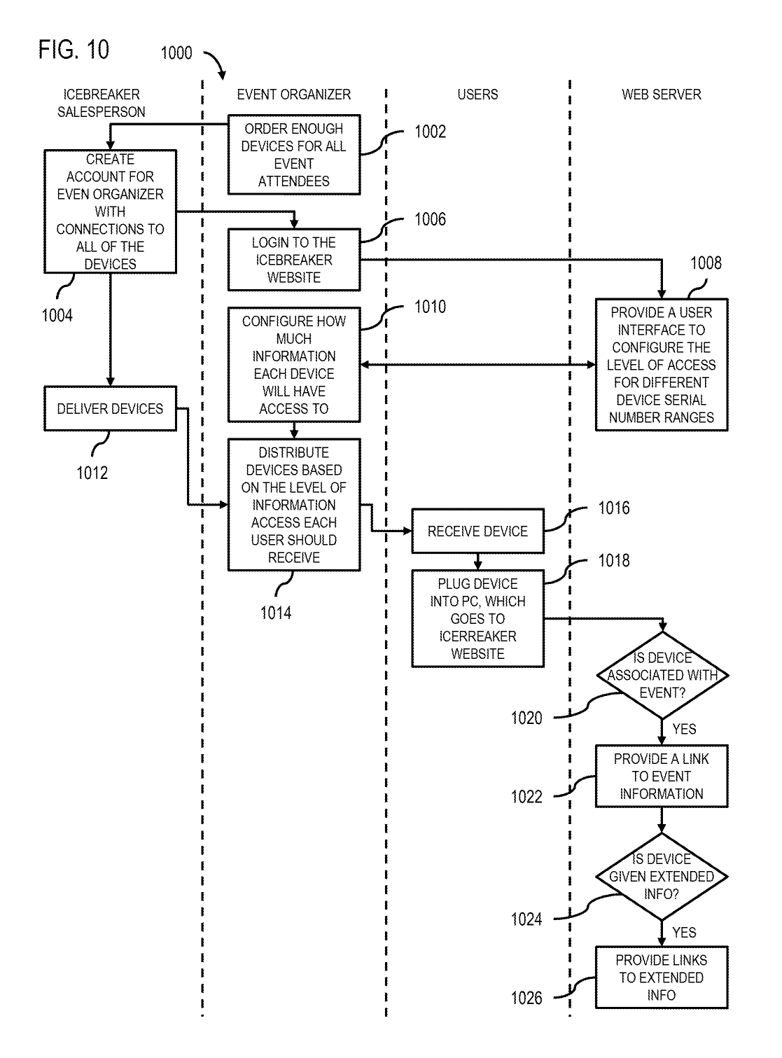

The device discussed in the scenarios of FIGS. 2-7 may be a very low cost device that can easily be replaced by a device provider. Such an approach is highly advantageous over other more costly devices for information exchange (e.g., PDAs, smart phones, tablet PCs, etc.). The content of FIG. 7 is further described with respect to a method for prepaying online for goods and/or services in the flow chart 1000 of FIG. 10. Additional scenarios where devices according to the presently disclosed technology could be employed include; prepaid coffee or food, prepaid copies, email or online coupons, ski lift tickets, concert tickets, monthly bus passes (if the passes periodically download a list of valid devices), and gym memberships.

FIG. 8 is a flowchart 800 illustrating operations for exchanging device identifiers between two or more of the handheld devices (Sammie devices 200), according to one embodiment. For example, a user acquires a Sammie device at a tradeshow or other event (step 802). The device is configured with at least one device ID that is specific to the device. If multiple device IDs are stored on the device, a selector such as a switch or button may be used to select one of the stored IDs and then transmit the selected ID to another device. The user activates a button on the device in the proximity to a second device possessed by second user at the event (step 804). If a green indicator light on the device illuminates, the device has successfully exchanged device IDs with the second device (step 806). From the perspective of the Sammie device, when the user activates the button (step 812), the device sends its device ID and receives any device IDs within its range (step 814). If there are any communication errors (step 816) resulting in a failure to send or receive the device IDs, a red light will illuminate (step 818) and the user will have to activate the switch again to restart the process. If the device ID is successfully sent and all device IDs within range are received, the green light will illuminate indicating the successful transmission of device IDs (step 820). When the user is done connecting with other users (step 808) and returns from the event to an area with a personal computer (e.g., his/her hotel room, office, and home), the device may be plugged into the personal computer (steps 810, 822). In some instances the device utilizes a USB connection, however other connections are contemplated (e.g., Wi-Fi, Bluetooth, and memory card). The device ID of the user's device and a list of received device IDs from other devices are uploaded to the computer (step 824).

FIG. 9 is a flowchart 900 illustrating operations for connecting a user to a web server and accessing information about other users through the web server, according to one embodiment. For example, users of a Sammie device may access a Sammie website (step 902). The website may prompt the user to enter a username and password or alternatively select a “new account” option (step 904). Existing users log on to the Sammie website using a username and a password. New Sammie users may select a “new account” option (step 908). If the user selects a “new account,” the website will prompt the user to enter basic information needed to create a new account (step 910). This information may include, but is not limited to name, address, phone number, credit card number, username, and password. This information may also reference an event instead of a specific user and the information may be referred to collectively as a target identifier.

Once the new account is activated or the user signs into an existing active account, the user may upload device IDs to the website (step 912) in the manner described with respect to FIG. 8. The website may then lookup the received device IDs in a database that associates user names with their respective device IDs (step 914). The user is then presented with a list of user names associated with the device IDs that he/she received (step 916). The list of user names may also include pictures or brief descriptions of each user to aid the user in remembering each user with which he/she exchanged device IDs. The user may then select one or more of the user names (step 918) to display information that the user has previously entered into the Sammie website (step 920).

FIG. 10 is a flowchart 1000 illustrating operations for configuring the handheld devices for an event, according to one embodiment. An event organizer approaches a Sammie sales representative or other authorized person about supplying devices for attendees of the event (step 1002). The sales representative may then obtain sufficient devices for the event and create an account for the event organizer within the Sammie website that grants at least limited access to all the devices intended to be used at the event (step 1004). The event organizer can then log onto the Sammie website (step 1006) to configure a level of access for various device IDs (steps 1008, 1010). For example, the event organizer may desire to have several groups of devices with varying levels of access intended to be provided to several groups of event attendees. Alternatively, the event organizer may configure all the devices to have the same level of access.

Once the devices are delivered to the event (step 1012), the devices can be distributed based on a level of access to information that each attendee of the event should receive (step 1014). After the attendees receive (step 1016) and use the devices at the event as described at least with respect to FIG. 8, the attendees may plug their respective devices into personal computers to download device IDs to the computers and the attendees can access the Sammie website (step 1018). When the attendees access the Sammie website, the website searches to see if the attendee's device is associated with a specific event (step 1020). If so, the attendee is provided with a link to event information (step 1022). Further, the website determines the attendee's level of access based on the device ID (step 1024) and grants the attendee access based on the device ID (step 1026).

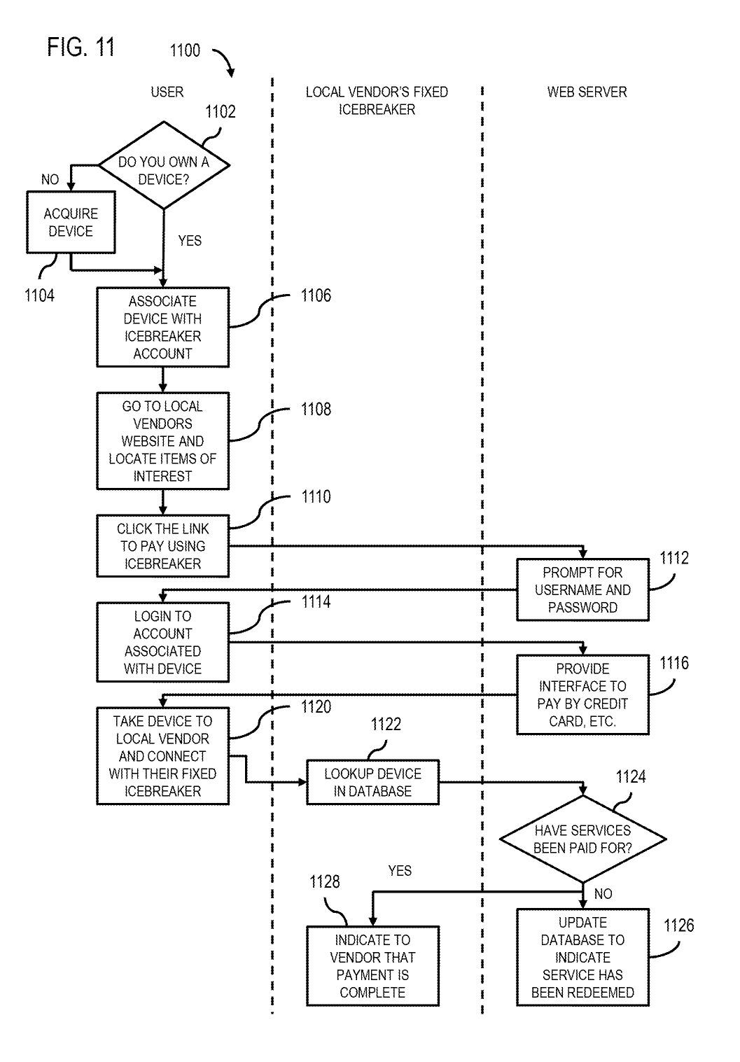

FIG. 11 is a flowchart 1100 illustrating operations for prepaying for goods or services accessed using the handheld device (Sammie devices 200), according to one embodiment. For example, if a user already owns a device (step 1102), the device is associated with the user's Sammie account (step 1106). Otherwise, the user obtains a device and the new device is associated with the user's Sammie account (step 1104). Then the user accesses a vendor's website (Sammy website) and locates one or more items of interest (step 1108). If the user decides to purchase one or more of the vendor's items, the user selects a “pay link” on the vendor's website that allows the Sammie to be used for payment (step 1110). The website prompts the user to provide a username and password to login to the user's Sammie account (step 1112).

After the user log in operation (step 1114), the Sammie account provides the vendor's website an interface with which to pay for the desired items (e.g., credit card, debit card, PayPal®, etc.) (step 1116). The user then may take his/her device to a local vendor of the desired items and “connect” the user's device with a fixed Sammie device at the vendor's physical location (step 1120). The user may also access a kiosk with the desired items and “connect” the user's device with a fixed Sammie device within the kiosk. The vendor may then automatically or manually look-up the user's device in a database (step 1122) that indicates what services or products have been paid for in operation (step 1124). The vendor may then provide the paid-for products or services to the user and indicate to the vendor website that the products or services have been delivered (step 1126). The user may also provide additional payment to the vendor and the vendor may indicate the additional payment to the vendor website (step 1128).

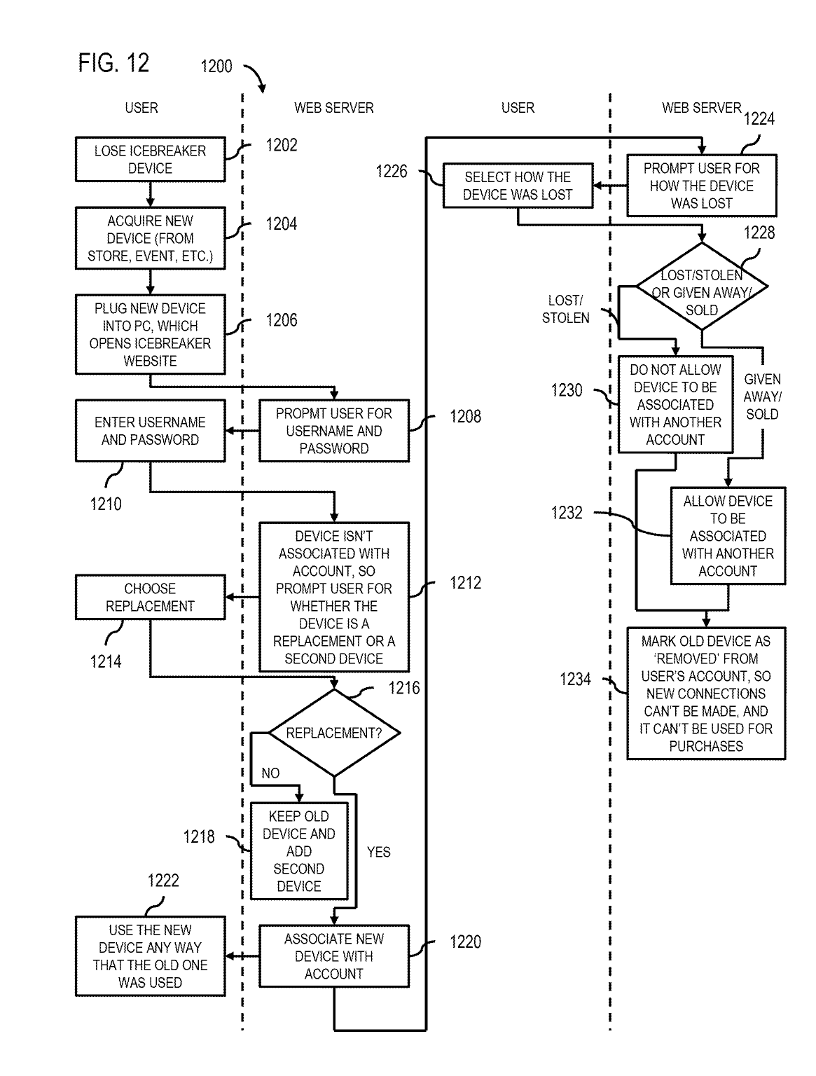

FIG. 12 is a flowchart 1200 illustrating operations for restoring account settings from a lost handheld device (or system 100), according to one embodiment. For example, at some point, a user may lose his/her Sammie device (step 1202). The user may then acquire a new device from a Sammie vendor (step 1204). The user plugs the new device into the user's personal computer and opens the Sammie website (step 1206). The Sammie website prompts the user to enter his/her username and password (step 1208). After the user's username and password are entered (step 1210), the Sammie website recognizes that the device plugged into the user's computer is not associated with the user's account (step 1212). The Sammie website then prompts the user to select whether the device is a “replacement device” or a “second device” (step 1216). If the user selects the “second device” option, the Sammie website keeps the old device and adds the new second device to the user's account (step 1218). If the user selects the “replacement device” option (step 1214), the Sammie website associates the user's account with the new device in operation (step 1220) and allows the new device to be used in the way that the lost device was used (step 1222).

The Sammie website may then prompt the user to provide the status of the first device (step 1224). For example, the device may have been lost, stolen, given away, or sold (step 1228). The user may select one of these options (step 1226). If the device was lost or stolen, the Sammie website will not allow the device to be associated with another account (step 1230). If the device was given away or sold, the Sammie website will allow the device to be associated with another account (step 1232). Regardless, the first device is removed from the user's account and the user can no longer use the first device to make new connection or make new purchases (step 1234).

One embodiment of the presently disclosed technology is a single device that is capable of having multiple device IDs that the user could associate with different amounts or types of information. For example, when connecting with other users, the user would select which device ID to use to suit the situation. For example, a user could have a web page with his favorite recipes that he wants to share with as many people as possible; however, he does not want all of those people to be able to email him.

A further embodiment contemplates an interest-based approach. After visiting the website and setting up a profile, a list of codes that indicate interests could be downloaded to the device. Then, when the user connects with someone with similar interests, the device could indicate that they are a “match”. It is also possible to have a limited number of codes to identify interests (e.g., gardening, hiking, stamp collecting, and bird watching) amongst users if desired.

In one embodiment, unlike most computer peripherals, the device may not require the user to install a driver or run an executable program. Therefore, the Sammie device is virus resistant. In one implementation, when the user plugs the device into his/her computer, the device integrates like a read-only USB flash drive that contains one file that is an internet shortcut. The operating system recognizes this file and prompts the user to follow the link. The internet shortcut contains a single parameter that is passed to the web server that contains the entire encrypted contents of the device. The link will also take the user to the web site where the user can create an account and enter information. The link may look something like this: http://Sammie.com/upload.php ?contents=1GUOEKCN433JV98656ENC983BD91HRBV89E93HJNVYROHUIRHG8483HF84GWOLS903HFVC8EHGF9ETR76593JF87EFEWBFD76FC54VGF7452VBF85GYO 8JKJH9BYTDT3SFS56CX46R85H568BG4H77G9JH4BG8DG385HFFBIOSDKJVV8DHE WOGHVNBDE93HF3G9FG4BV7V6E74BJ2B3H59R496HG554W4RJ9. The device could also connect to any executable program such as an API (application programming interface).

In one embodiment, in addition to the IR communication approach that is discussed with specificity herein, the presently disclosed technology also comprehends other techniques for inter-device communication to include any other communication method such as a physical connector, or radio frequency such as Bluetooth, Wi-Fi, Zigbee, or even a proprietary communication protocol.

A further embodiment comprehends a device that is configured as a memory card such as Compact Flash (CF) or Secure Digital (SD) that plugs into another processing device. Like the USB version, the device would appear to software as a memory card with files on it, so any device that can make the files on its card accessible by a computer may work. The types of other processing devices include, but are not limited to, MP3 players, PDAs, Tablet PC, and wireless phones (e.g., smart phones). The card itself could have the standard application program and methods embodied thereon, and furthermore may include a button switch to initiate a connection as described above.

In a further embodiment, the device and methods according to the presently disclosed technology may be embodied as a JAVA (or other portable language) software application running on a wireless phone (e.g., smart phone). As such, the phone's short-range communication methods (e.g., Bluetooth® NFC or infrared), unique identifier (e.g., ESN or IMEI), and memory would be employed to effect connection and transfer of data. For example, the software application running on the smart phone may be launched as the user selects a device ID that may be specific to another user. The selected device ID may be transmitted to the smart phone through the NFC or Bluetooth communication methods, and the application may access and present profile information associated with the selected device ID.

In one embodiment, potential advantages of the presently disclosed technology include one or more of the following. Multiple device IDs can be allowed on each device. Exchange security is protected because only a device ID or token is exchanged, not the actual data itself. The recipient of the anonymous device ID from an “exchange” simply has the other user's device ID and may be precluded from accessing any information associated with the providing user until that user registers his/her device, or depending on access levels associated with the device ID. The user information is not stored in the device. When a user receives a device at an event, the user can immediately start “connecting” with people, rather than requiring access to a computer to enter his/her information first. If a device is reported lost or stolen, the website can disallow the device from being re-registered. If someone finds the old device, the information and prepaid values will remain secure. A vendor could check a picture on the user's web site to compare it with the person to return a lost device to a user. If a user loses his device, none of his information or prepaid values is lost because that information is not stored on the device.

In one embodiment, the devices need very little memory and user interface software and are therefore inexpensive. If a user connects with a vendor, he/she can decide later whether or not to give the vendor access to his contact information. An event organizer that gives the devices to ticket buyers can give the devices information and access without having to physically connect to the devices. If the device is replaced, all information is secure and associated with the new device, without requiring any action by the vendor. Without having to open an account locally with a particular vendor, a user can pay for local goods and services online using the device.

In one embodiment, if an event organizer gives additional access to certain users, each device can only be associated with one account. A user must be logged in to his/her account to access the additional content, so only one user may gain access to the device at a time. This login requirement prevents hackers from posting links to the protected content.

In one embodiment, each user has a table of contacts stored on the web site that has entry points to information he/she has prepared to exchange. For each contact, he/she creates a list of these entry points that the other user can access. This list can change over time.

In one embodiment, the system has the capability to point to another web site for advertising or additional information. Thus at a trade show, a vendor might beam his “shared information” to a passing attendee who could then access the requested information on the vendor's web site.

In one embodiment, given the simplicity of the device, another embodiment contemplates an add-in device that can be added or attached to a cell phone, smart phone, tablet PC, PDA, etc. to achieve the same functionality as the low-cost dedicated devices.

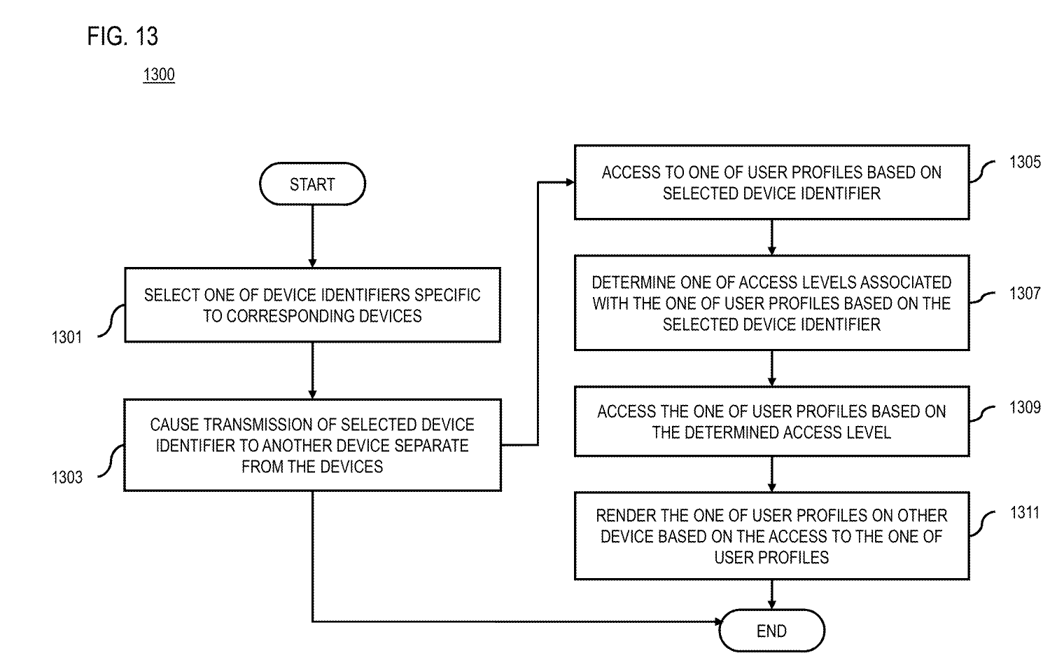

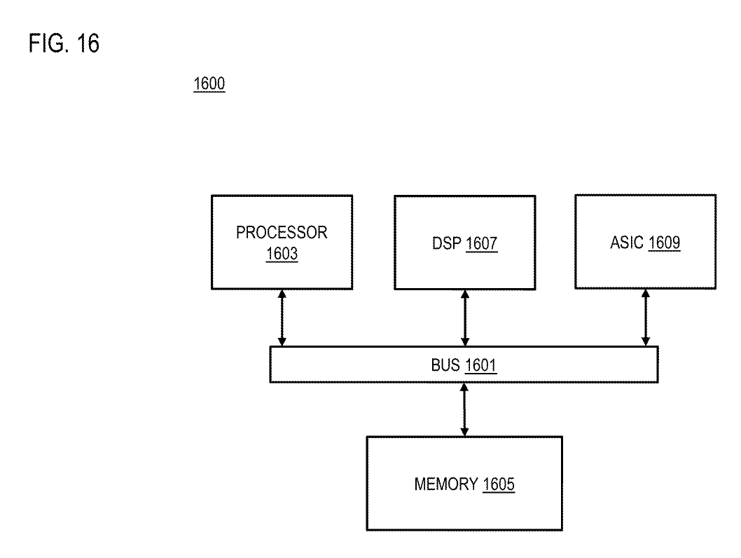

FIG. 13 is a flowchart of a process for providing an exchange of profile information by using anonymous identifiers, according to one embodiment. In one embodiment, the process 1300 may be implemented in, for instance, a chip set including a processor and a memory as shown in FIG. 16. For example, the process 1300 may be implemented in the processor (or microcontroller) 103 of the system 100.

In step 1301 of the process 1300, the processor 103 may select one of a plurality of device identifiers specific to corresponding one or more devices. The plurality of device identifiers may be associated with one or more user profiles. For example, as a user selects one of the device identifiers by using the selector (or the button) 102 of the system 100, the processor 103 receives the user selection input and selects/determines one of the device identifiers based on the user selection input. The device identifier may be associated with personal or business profile information associated with a social network website, a blog website, a personal webpage, a dating website, etc.

In one embodiment, the device identifiers may be anonymous device identifiers. For example, the device identifier may not contain any personal information or other data about the user, but merely contain unique device identifier information (e.g., MAC address, ID number, etc.). Personal information may be revealed as the user tries to access the profile information associated with the identifier information (e.g., MAC address, ID numbers, etc.) through a web server.

In one embodiment, the one or more user profiles may be associated with one or more access levels to the one or more user profiles. For example, different portions of the user's profile information may be associated with different access levels. Thus, corresponding portions of the user's profile information may be accessed based upon verification of the access levels associated with the device identifier. For example, a user may have three different device identifiers. A first device identifier may be associated with acquaintance-level information (e.g., name, picture, and email address), a second device identifier may be associated with business-level information (e.g., name, picture, email address, occupation/title, education, business address, business number, business website, etc.), and a third device identifier may be associated with personal information (e.g., name, email, occupation, education, business address, phone number, birthday, activities, hobbies, relationship status, friends, etc.).

In one embodiment, the one or more access levels to the one or more user profiles may be preset by corresponding one or more users in association with the plurality of device identifiers. For example, a user may set or modify an access level for the profile information associated with the user's device identifiers using an application or a webpage. The application or web page may interact with a web server that may manage the device identifiers. A user interface of the application or webpage may require account log-in information (e.g., ID and password) when the user tries to register or modify the user's device identifiers on the server. If the user does not have an account with the web server, the user may be invited to create one.

In step 1303, the processor 103 may cause, at least in part, a transmission of the selected device identifier to another device, separate from the one or more devices. For example, the other device may include the other user's handheld device (e.g., Sammie device), the user's other device (e.g., smart phone, tablet PC, etc.), and other user's another device (e.g., smart phone, tablet PC, etc.) that can receive the device identifier.

In one embodiment, the selected device identifier in step 1301 may be a user's own device identifier or a received other user's device identifier. If the selected device identifier is the user's own device identifier, the device identifier may be transmitted to the other user's handheld device (e.g., Sammie device) for an exchange of the device identifier. On the other hand, if the selected device identifier is the other user's device identifier, the device identifier may be transmitted to the user's another device to access the other user's profile information.

In one embodiment, the transmission may be wireless using a Bluetooth connection, and/or a Near Field Communication (NFC) connection. For example, as the handheld device (Sammie device) approaches the other device (e.g., other Sammie device or smart phone) within a NFC signal range, a connection may be established with the selection of the device identifier made and/or connection button pressed. With this NFC connection, the handheld device may be coupled with the other device and the selected device identifier may be transmitted to the other device. In another embodiment, a Bluetooth connection may be used in the coupling and the transmission to the other device instead of the NFC connection. In one embodiment, because the Bluetooth connection may require an initiation (setup) process, which may be manual and cumbersome, before a transmission is made, the NFC connection may be used in combination with the Bluetooth connection. For example, the NFC connection may be used for an instant initial connection (or setup) of the Bluetooth connection between the devices, and the device identifier may be transmitted via the initiated Bluetooth connection thereafter.

In step 1305, the processor 103 may access one of the one or more user profiles based, at least in part, on the selected device identifier. For example, as the connection is made between the handheld device and the other device (e.g., smart phone) via the NFC or Bluetooth connection, and the device identifier is transmitted to the other device as in step 1303, an application on the other device may be caused to access a corresponding user profile information based on the received device identifier. The application may initially connect to the web server managing the device identifiers and their associated user accounts. Thereinafter, the application may download the profile information directly from the web server, or may download a web address (e.g., URL) to a user profile webpage. The user profile webpage may be a part of a personal website, blog website, social network service website, or dating website. The application may present the downloaded profile information on the application browser or access the profile information webpage through the application browser or other internet browser, based on the web address.

In step 1307, the processor 103 may determine one of the one or more access levels associated with the one of the one or more user profiles based, at least in part, on the selected device identifier. For example, when the processor 103 initiates an attempt to access the profile information based on the device identifier, as in step 1305, a pre-defined access level associated with the device identifier may be determined based on the device identifier. The device identifier may be pre-registered with: the web server managing the device identifiers; associated user accounts; and at least one level of access may be assigned to the device identifier. In that way, the server may verify the device identifier, and access levels associated with the device identifier may be determined through the verification, based on the registration data of the device identifiers.

In step 1309, the processor 103 may access the one of the one or more user profiles based, at least in part, on the determined access level. For example, when the access level associated with the device identifier is determined, as in step 1307, the profile information or portions of profile information corresponding to the access level of the device identifier may be accessed based on the determined access level. The profile information, or a web address containing the profile information, may be stored in the server managing the profile information and the associated user accounts. The profile information may be accessed using the web addresses to the profile information, which may be displayed according to the access level allowed for the user seeking the profile information.

In step 1311, the processor 103 may render the one of the one or more user profiles on the other device based, at least in part, on the access to one of the one or more user profiles. For example, when the profile information associated with the device identifier is accessed as in step 1309, the accessed information may be downloaded to the user's handheld device (e.g., Sammie device) or another device (e.g., mobile phone, smart phone, desktop computer, laptop, tablet PC, etc.) to render the information on the user's handheld device or the other device. The downloaded profile information may be rendered on an application or a web browser on the user's handheld device or the other device.

In another embodiment, the system 100 may include a selector that receives a user input; a processor configured to select one of a plurality of device identifiers specific to corresponding to one or more devices based on the user input; a transceiver configured to transmit the selected device identifier to other device; a circuitry connected to the selector, the processor, and the transceiver; and a housing containing the selector, the processor, the transceiver, and the circuitry. The plurality of device identifiers may be anonymous device identifiers. In one embodiment, the transceiver may be configured to transmit the device identifiers wirelessly using a Bluetooth connection, and/or a Near Field Communication (NFC) connection. The system may be implemented into a handheld device (e.g., Sammie device).

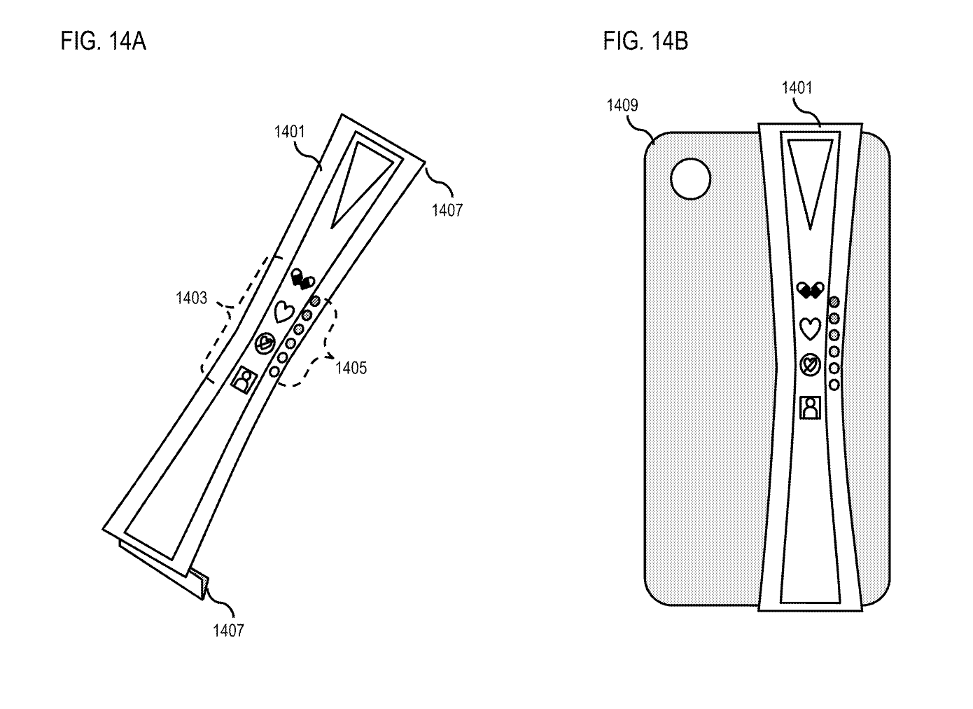

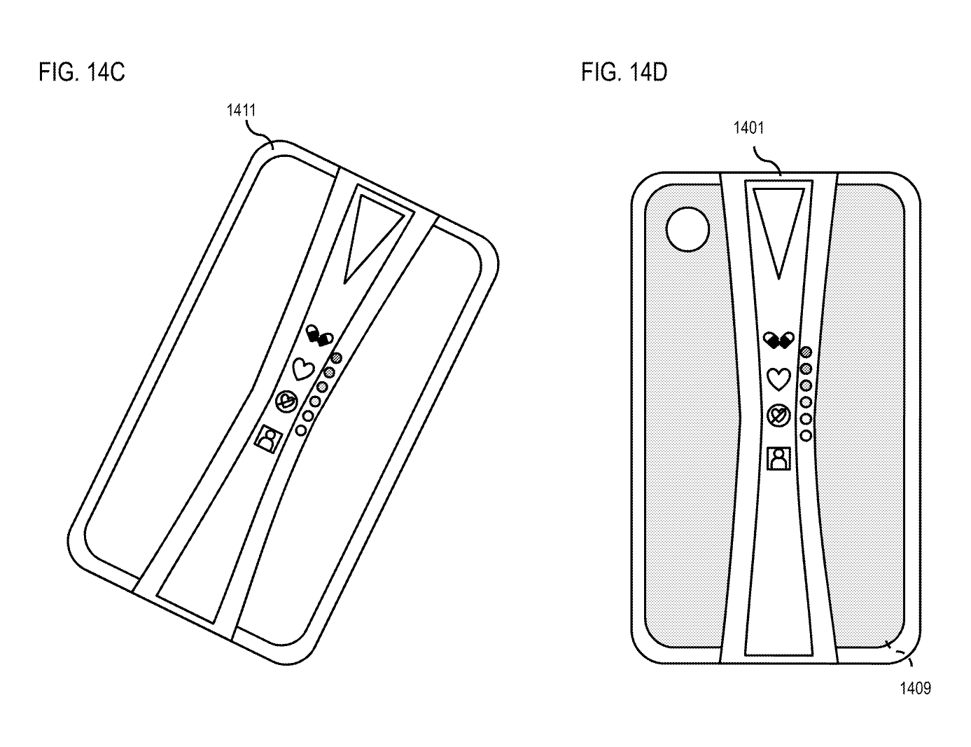

FIGS. 14A-14D are diagrams illustrating a handheld device for providing an exchange of profile information by using anonymous identifiers, according to various embodiment. FIG. 14A is a diagram illustrating a handheld device (Sammie device) 1401 implemented in the system 100, according to one embodiment. The handheld device may include Group 1 buttons (or selectors) 1403 and Group 2 buttons (or selectors) 1405. The Group 1 and 2 buttons (1403 and 1405, respectively) may in various forms be capable of receiving a user's input. For example, the Group 1 buttons 1403 may be associated with the one or more device identifiers in the user's handheld device. Each of the Group 1 buttons 1403 may be associated with different levels of access (e.g., minimum disclosure, mid-level disclosure, full disclosure, etc.) to the user's profile information or different types of profile information. For example, the first button of the Group 1 buttons 1403 may be associated with a Facebook profile page, the second button of the Group 1 buttons 1403 may be associated with the user's blog profile page, the third button of the Group 1 buttons 1403 may be associated with the user's dating website profile page, etc. As the user selects one of the Group 1 buttons 1403, a device identifier of the user device 1401 associated with the selected button may be transmitted to another user's handheld device (e.g., other Sammie device). The association between the button and the device identifier may be pre-defined through an application on a user's other device (e.g., smart phone, desktop, tablet PC, etc.), which the handheld device may be connected to. The application may access the web server that may manage the user accounts and the associated profile information.

Further, the Group 2 buttons 1405 may be associated with the one or more device identifiers received from the other user devices. Each of the Group 2 buttons 1405 may be associated with a different device identifiers of other users. Also, the Group 2 button(s) 1405 may contain navigating-type button(s) that allow the user to navigate across device identifiers. As one of the device identifiers of another is selected, the selected device identifier may be transmitted to another device (e.g., smart phone, desktop, tablet PC, etc.). The transmission of the device identifier may trigger launching an application on the other device, and accessing profile information based on the device identifier.

In one embodiment, the handheld device 1401 may have one group of buttons or a selector which may allow navigating through device identifiers including the user's device identifiers or device identifiers received from other users. Thus, depending on type (e.g., user's own device identifier or other user's device identifier) of the device identifier selected, a next action may be determined. The next action may include a transmission of the user's device identifier to another user's device or a transmission of other user's device to user's other device to access the other user's profile information through the user's other device. In one embodiment, the handheld device 1401's display may present the device identifiers stored in the handheld device 1401, so that users can navigate various device identifiers.

Further, as shown in FIGS. 14A-14B, the housing of the handheld device (Sammie device) 1401 may be coupled to other devices, including mobile phones. For example, the handheld device 1401 may include clip-on parts 1407 that clips or embraces the other device such as a mobile phone (e.g., smart phone) 1409. The clip-on parts 1407 may be formed on the opposite end of the housing of the device 1401. The handheld device 1401 may be attached or detached with the mobile phone (e.g., smart phone) 1409. In that way, the handheld device 1401 may be carried by itself or with the mobile phone 1409.

In one embodiment, as shown in FIG. 14C-14D, the housing of the handheld device 1401 (Sammie device) may include a protective case for the mobile phone. The clip-on parts 1407 may be extended into a shape that can cover the boundaries or surfaces of the mobile phone. In that way, the extended parts 1411 of the housing may further embrace the mobile phone 1409 and provide protection for the mobile phone 1409. The extended parts 1411 may include materials, such as rubber, plastic, metal, etc., to help absorb shock in case there is accidental physical impact on the device. Further, an antenna capable of attracting signals from a greater distance for the mobile phone 1409 may be embedded in the extended parts 1411. Thus, the handheld device's housing may serve multiple purposes, such as covering and protecting the mobile phone 1409 from damages or increasing its signal strength. In one embodiment, the handheld device (Sammie device) may be built into one of protective cases (for the mobile phones) of various shapes.

The processes described herein for providing an exchange of profile information by using anonymous identifiers may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

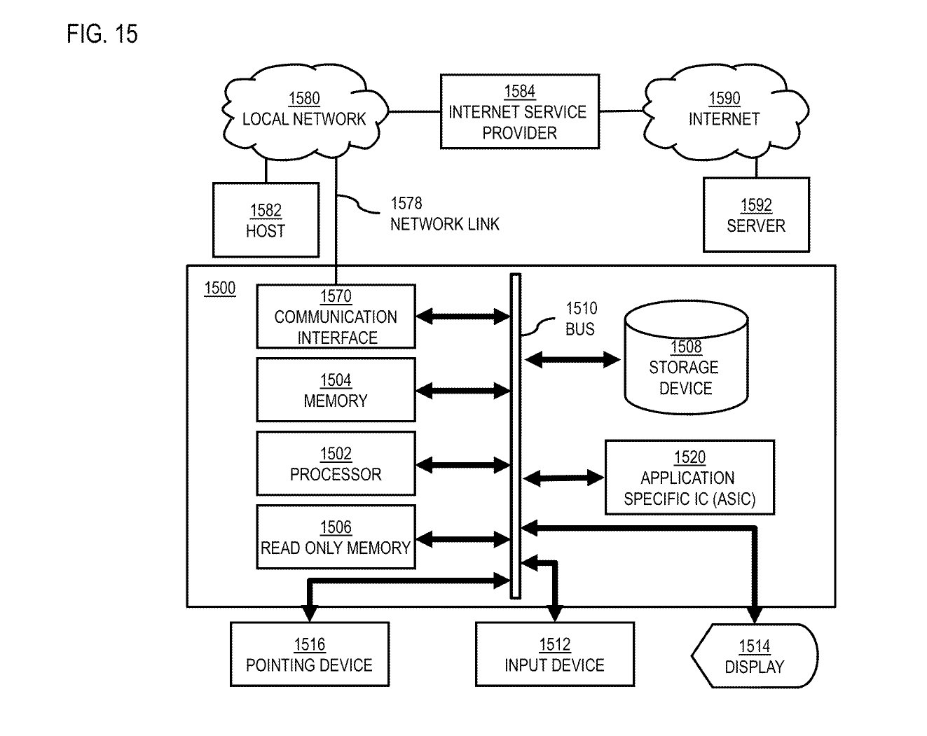

FIG. 15 illustrates a computer system 1500 upon which an embodiment of the invention may be implemented. Although computer system 1500 is depicted with respect to a particular device or equipment, it is contemplated that other devices or equipment (e.g., network elements, servers, etc.) within FIG. 15 can deploy the illustrated hardware and components of system 1500. Computer system 1500 is programmed (e.g., via computer program code or instructions) to provide exchange of profile information by using anonymous identifiers as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of providing an exchange of profile information by using anonymous identifiers.

A bus 1510 includes one or more parallel conductors of information so that information is transferred quickly among devices coupled to the bus 1510. One or more processors 1502 for processing information are coupled with the bus 1510.

A processor (or multiple processors) 1502 performs a set of operations on information as specified by computer program code related to provide exchange of profile information by using anonymous identifiers. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1500 also includes a memory 1504 coupled to bus 1510. The memory 1504, such as a random access memory (RAM) or any other dynamic storage device, stores information including processor instructions for providing an exchange of profile information by using anonymous identifiers. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or any other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for providing an exchange of profile information by using anonymous identifiers, is provided to the bus 1510 for use by the processor from an external input device 1512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a cathode ray tube (CRT), a liquid crystal display (LCD), a light emitting diode (LED) display, an organic LED (OLED) display, a plasma screen, or a printer for presenting text or images, and a pointing device 1516, such as a mouse, a trackball, cursor direction keys, or a motion sensor, for controlling a position of a small cursor image presented on the display 1514 and issuing commands associated with graphical elements presented on the display 1514. In some embodiments, for example, in embodiments in which the computer system 1500 performs all functions automatically without human input, one or more of external input device 1512, display device 1514 and pointing device 1516 is omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of ASICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners and external disks. In general the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver.

The term “computer-readable medium” as used herein refers to any medium that participates in providing information to processor 1502, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 1508. Volatile media include, for example, dynamic memory 1504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1520.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system 1500 can be deployed in various configurations within other computer systems, e.g., host 1582 and server 1592.

At least some embodiments of the invention are related to the use of computer system 1500 for implementing some or all of the techniques described herein. According to one embodiment of the invention, those techniques are performed by computer system 1500 in response to processor 1502 executing one or more sequences of one or more processor instructions contained in memory 1504. Such instructions, also called computer instructions, software and program code, may be read into memory 1504 from another computer-readable medium such as storage device 1508 or network link 1578. Execution of the sequences of instructions contained in memory 1504 causes processor 1502 to perform one or more of the method steps described herein. In alternative embodiments, hardware, such as ASIC 1520, may be used in place of or in combination with software to implement the invention. Thus, embodiments of the invention are not limited to any specific combination of hardware and software, unless otherwise explicitly stated herein.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server host 1592 transmits program code for a particular application, requested by a message sent from computer 1500, through Internet 1590, ISP equipment 1584, local network 1580 and communications interface 1570. The received code may be executed by processor 1502 as it is received, or may be stored in memory 1504 or in storage device 1508 or any other non-volatile storage for later execution, or both. In this manner, computer system 1500 may obtain application program code in the form of signals on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set or chip 1600 upon which an embodiment of the invention may be implemented. Chip set 1600 is programmed to providing an exchange of profile information by using anonymous identifiers as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1600 can be implemented in a single chip. It is further contemplated that in certain embodiments the chip set or chip 1600 can be implemented as a single “system on a chip.” It is further contemplated that in certain embodiments a separate ASIC would not be used, for example, and that all relevant functions as disclosed herein would be performed by a processor or processors. Chip set or chip 1600, or a portion thereof, constitutes a means for performing one or more steps of providing user interface navigation information associated with the availability of functions. Chip set or chip 1600, or a portion thereof, constitutes a means for performing one or more steps of providing an exchange of profile information by using anonymous identifiers.

In one embodiment, the chip set or chip 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1600 includes merely one or more processors and some software and/or firmware supporting and/or relating to and/or for the one or more processors.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to providing an exchange of profile information by using anonymous identifiers. The memory 1605 also stores the data associated with or generated by the execution of the inventive steps.

What is claimed is:

1. An apparatus comprising:
at least one processor; and
at least one memory including computer program code for one or more programs,
the at least one memory and the computer program code configured to, with the at least one processor, cause the apparatus to perform at least the following,
select one of a plurality of device identifiers specific to corresponding one or more devices; and
cause, at least in part, a transmission of the selected device identifier to another device separate from the one or more devices,
wherein the plurality of device identifiers are associated with one or more user profiles.

2. An apparatus of claim 1, wherein the plurality of device identifiers are anonymous device identifiers.

3. An apparatus of claim 1, wherein the transmission is wireless using a Bluetooth connection, a Near Field Communication (NFC) connection, or a combination thereof.

4. An apparatus of claim 1, wherein the apparatus is further configured to:
access to one of the one or more user profiles based, at least in part, on the selected device identifier.

5. An apparatus of claim 4, wherein the apparatus is further configured to:
render the one of the one or more user profiles on the other device based, at least in part, on the access to one of the one or more user profiles.

6. An apparatus of claim 1, wherein the one or more user profiles are associated with one or more access levels to the one or more user profiles.

7. An apparatus of claim 6, wherein the one or more access levels to the one or more user profiles are preset by corresponding one or more users in association with the plurality of device identifiers.

8. An apparatus of claim 6, wherein the apparatus is further configured to:
determine one of the one or more access levels associated with the one of the one or more user profiles based, at least in part, on the selected device identifier; and
access the one of the one or more user profiles based, at least in part, on the determined access level.

9. A method comprising:
selecting one of a plurality of device identifiers specific to corresponding one or more devices; and
initiating transmission of the selected device identifier to another device separate from the one or more devices,
wherein the plurality of device identifiers are associated with one or more user profiles.

10. A method of claim 9, wherein the plurality of device identifiers are anonymous device identifiers.

11. A method of claim 9, wherein the transmission is wireless using a Bluetooth connection, a Near Field Communication (NFC) connection, or a combination thereof.

12. A method of claim 9, further comprising:
accessing one of the one or more user profiles based, at least in part, on the selected device identifier.

13. A method of claim 9, wherein the one or more user profiles are associated with one or more access levels to the one or more user profiles.

14. A method of claim 13, wherein the one or more access levels to the one or more user profiles are preset by corresponding one or more users in association with the plurality of device identifiers.

15. A method of claim 13, further comprising:
determining one of the one or more access levels associated with the one of the one or more user profiles based, at least in part, on the selected device identifier; and
accessing the one of the one or more user profiles based, at least in part, on the determined access level.

16. A system comprising:
a selector that receives a user input;
a processor configured to select one of a plurality of device identifiers specific to corresponding one or more devices based on the user input;
a transceiver configured to transmit the selected device identifier to other device;
a circuitry connected to the selector, the processor, and the transceiver; and
a housing containing the selector, the processor, the transceiver, and the circuitry,
wherein the plurality of device identifiers are associated with one or more user profiles.

17. A system of claim 16, wherein the plurality of device identifiers are anonymous device identifiers.

18. A system of claim 16, wherein the transceiver is configured to transmit wirelessly using a Bluetooth connection, a Near Field Communication (NFC) connection, or a combination thereof.

19. A system of claim 16, wherein the housing is coupled to other device that includes a mobile phone.

20. A system of claim 19, wherein the housing includes a protective case for the mobile phone.
